(19) United States
(12) Patent Application Publication
(10) Pub. No.: US 2015/0082211 A1
(43) Pub. Date: Mar. 19, 2015

(54) TERMINAL AND METHOD FOR EDITING USER INTERFACE

(71) Applicant: Pantech Co., Ltd., Seoul (KR)

(72) Inventor: Zoo Hyun LEE, Seoul (KR)

(21) Appl. No.: 14/487,970

(22) Filed: Sep. 16, 2014

(30) Foreign Application Priority Data
Sep. 17, 2013 (KR) 10-2013-0112135

(51) Int. Cl. G06F 3/0484

(52) U.S. Cl. CPC G06F 3/04845; G06F 3/04847
USPC 715/763

(57) ABSTRACT

A terminal for editing a user interface includes: an input unit for receiving an input of a user; a user interface (UI) editing module for providing a grid which is editable according to an input of the user, the UI editing module mapping a graphic item and a specific function which are to be connected to the grid; and a display unit for displaying a UI configured by the UI editing module. Accordingly, the UI on the terminal may be edited in various ways according to a demand or taste of the user.

### CROSS-REFERENCE TO RELATED APPLICATION

This application claims priority to Korean Patent Application No. 10-2013-0112135, filed on Sep. 17, 2013, and all the benefits accruing therefrom under 35 U.S.C. §119, the contents of which in its entirety are herein incorporated by reference.

### BACKGROUND

1. Field

The present disclosure relates to a terminal and method for editing a user interface, and more particularly, to a terminal and method for allowing a user to edit a user interface in various ways.

2. Description of the Related Art

Along with the recent development of smart phones, users execute various functions on the smart phones. In addition to smart phones, various mobile devices having a touch-screen function such as navigators, tablet computers or the like are also becoming popular.

In such mobile devices, user interface (hereinafter, referred as “UI”) screens such as a menu screen, a standby screen, a list, a player or a viewer are programmed in advance as software, and thus a user may not change the UI screens as desired.

However, a manufacturer may set a UI to be partially configurable, for example changing an icon location in a menu screen within a predetermined range. However, in this case, a user can typically select a cell of a specific predetermined size and apply a graphical element to the corresponding cell, or a user can select a preset grid layout and edit its graphic display only within a limited range.

Therefore, the present UI configurations are limited in design, and there is a need for a function which allows a user to edit a UI in various ways as desired.

### SUMMARY

The present disclosure is directed to providing a terminal capable of editing a UI in various ways.

The present disclosure is also directed to providing a method for editing a UI in the terminal.

According to the terminal and method for editing a user interface as described above, a function for selecting a grid layout to edit a UI and a function for graphically decorating a cell are provided so that a user may efficiently edit the UI. Therefore, a user may configure various UI designs as desired.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing a terminal according to an embodiment of the present disclosure.

FIG. 2 shows various screens of a grid cell merging mode in the terminal of FIG.

FIG. 3 shows various screens of a grid cell splitting mode in the terminal of FIG.

FIG. 4 shows various screens of a grid cell interval adjusting mode in the terminal of FIG. 1.

FIG. 5 is a flowchart for illustrating a method for editing a user interface according to an embodiment of the present disclosure.

FIGS. 6 and 7 show various screens in which a graphical element of a cell is edited, in the terminal of FIG. 1.

FIG. 8 is a diagram showing a layer of a graphical element of a cell.

FIG. 9 is a diagram showing an auto scroll of a cell focus.

### DETAILED DESCRIPTION

Hereinafter, a terminal and method for editing a user interface according to an embodiment of the present disclosure will be described in detail with reference to the accompanying drawings.

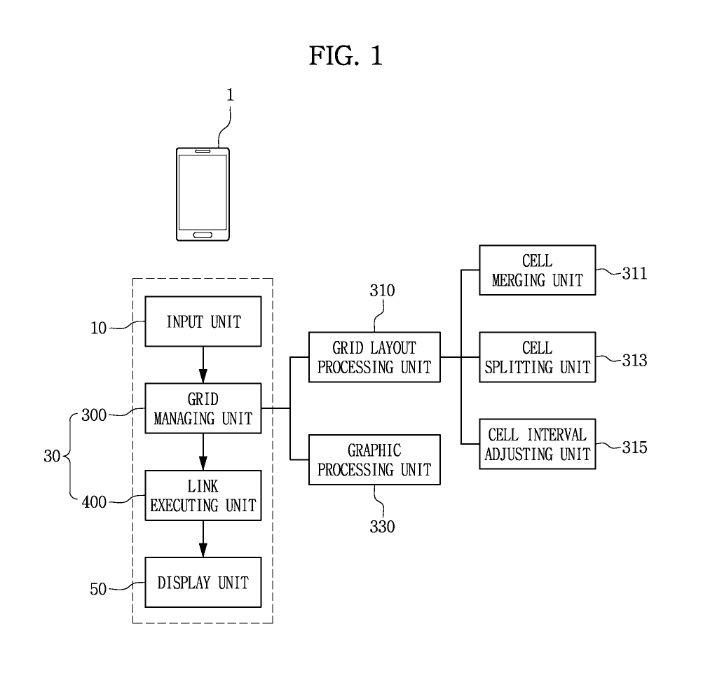

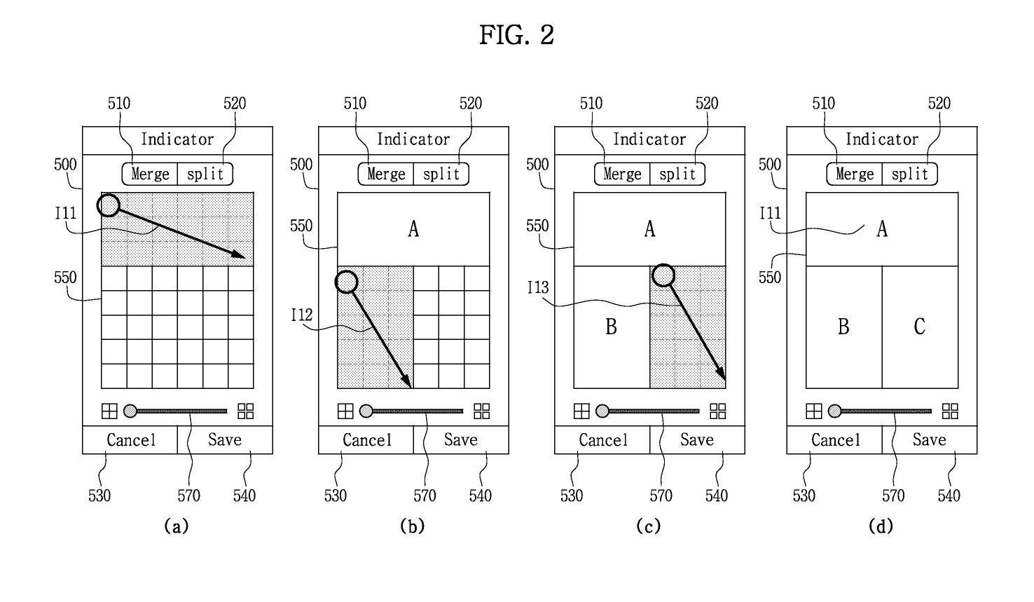

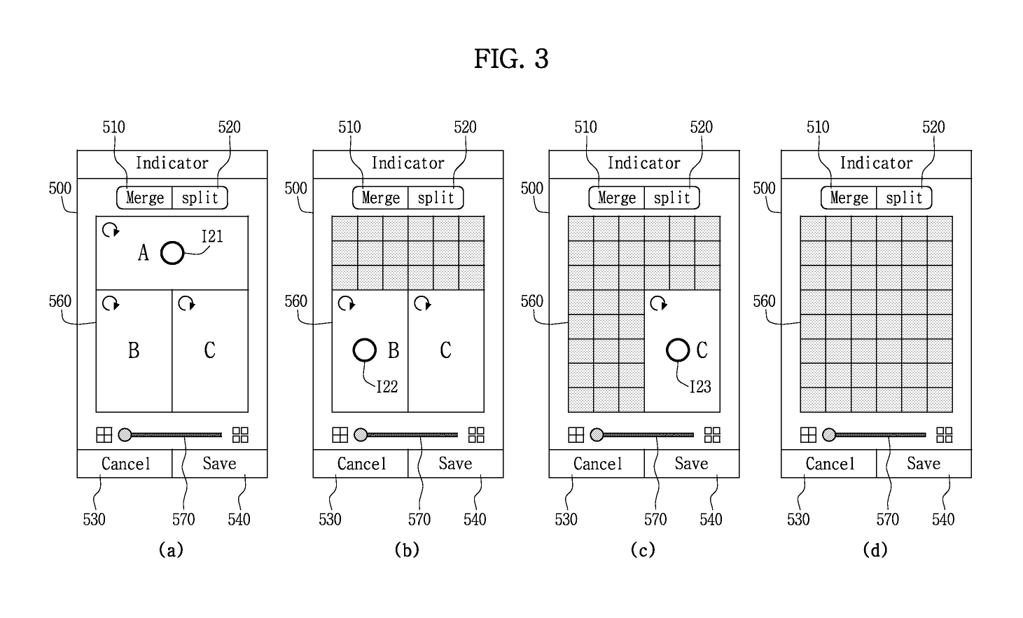

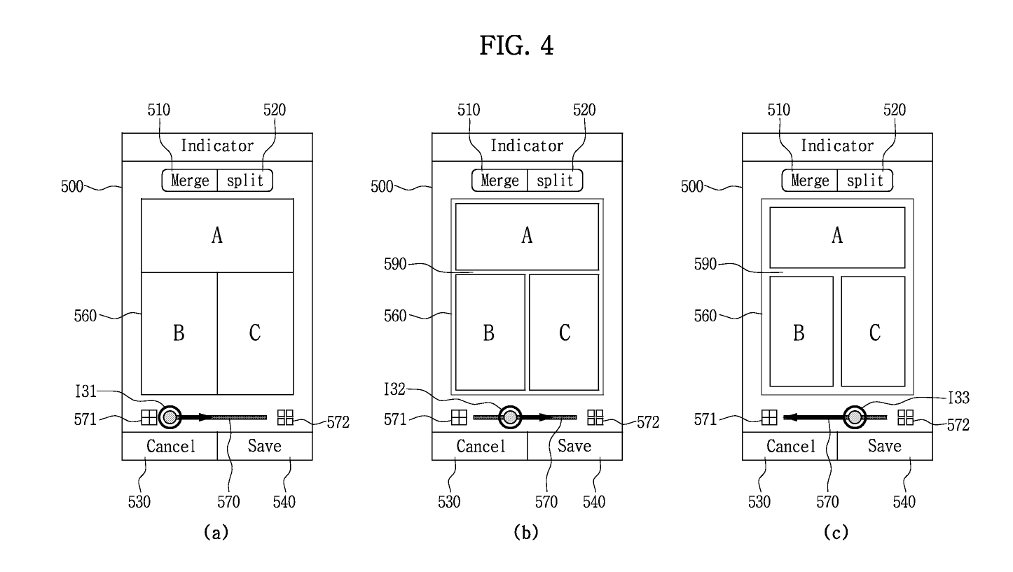

FIG. 1 is a block diagram showing a terminal according to an embodiment of the present disclosure. FIG. 2 shows various screens of a grid cell merging mode in the terminal of FIG. 1. FIG. 3 shows various screens of a grid cell splitting mode in the terminal of FIG. 1. FIG. 4 shows various screens of a grid cell interval adjusting mode in the terminal of FIG. 1.

Referring to FIG. 1, a terminal 1 according to the present disclosure includes an input unit 10 for receiving an input of a user to detect a resultant event, a UI editing module 30 for providing a user interface editing function, and a display unit 50 for displaying a screen.

The terminal 1 may be fixed or movable, and may also be called in other ways, for example user equipment (UE), a mobile station (MS), a mobile terminal (MT), a user terminal (UT), a subscriber station (SS), a wireless device, a personal digital assistant (PDA), a wireless modem, a handheld device or the like.

As a device supporting wireless communication, the terminal 1 may employ various kinds of mobile devices such as a smart phone, a cellular phone, a tablet computer, a notebook, a net book, a personal digital assistant (PDA), a portable multimedia player (PMP), a play station portable (PSP), an MP3 player, an e-book reader, a navigator, a smart camera, an electronic dictionary, an electronic clock, a game player or the like as well as electronic devices having any kind of communication function such as a desktop, a smart TV, a printer, a facsimile or the like.

The terminal 1 may execute various kinds of application programs based on an operating system (OS). The OS is a system program for allowing an application program to use hardware of the terminal, and may employ mobile computer operating systems such as Android OS, iOS, Windows Mobile OS, Bada OS, Symbian OS, Blackberry OS or the like as well as computer operating systems such as Window-series operation systems, Linux-series operating systems, Unix-series operating systems, MAC, AIX, HP-UX or the like.

The application program is a program developed to perform specific work by using a terminal device and may employ various multimedia content such as games, moving pictures and photos, or any kind of program such as an image viewer or a moving picture regenerator using such multimedia content as well as various applications and service objects.

The terminal 1 may display an application program through the display unit 50 or provide a UI to a user through the display unit 50. The display unit 50 may employ a liquid crystal display (LCD) panel, a plasma display panel (PDP), an organic light-emitting diode (OLED) display panel, electronic paper, electroluminescent displays or the like.

In addition, in order to process an input of the user, a touch-screen function may be included in the display unit 50 or provided using a separate touch pad device. In other cases, the terminal 1 may also include an input unit (not shown) such as a keypad which is formed separately from the display unit 50 to receive an input of the user.

The UI editing module 30 includes a grid managing unit/grid manager 300 and a link executing unit/link executer 400. The UI editing module 30 may be a module included in the terminal 1 or an application installed at the terminal 1. The UI editing module 30 may provide an editing tool interface through the display unit 50 for efficient editing.

The grid managing unit 300 provides a menu and an interface for editing the UI to the user, and the user may intuitively design a layout and graphic of the UI by using the menu and the interface. In the present disclosure, the UI may include any of application icons, widgets, thumbnails, home screens or the like.

The grid managing unit 300 provides a grid according to an event corresponding to the input of the user, separates the grid based on editable cell units, and processes a graphical element of each cell. For this, the grid managing unit 300 includes a grid layout processing unit/grid layout processor 310 for separating a layout of the grid based on editable cell units and a graphic processing unit/graphic processor 330 for adding the graphical element of each cell.

The grid layout processing unit 310 includes a cell merging unit/cell merger 311, a cell splitting unit/cell splitter 313 and a cell interval adjusting unit/cell interval adjuster 315 in order to provide a cell merging mode, a cell splitting mode and a cell interval adjusting mode of the grid and execute each task. The cell merging mode, the cell splitting mode and the cell interval adjusting mode may be executed according to different user inputs.

First, referring to FIG. 2 to explain the cell merging mode, a grid 550 is provided to a screen 500 which is provided to edit a layout of the grid. For example, the grid is composed of 6×8 cells. In addition, various menus required for editing are provided, which include a merging menu 510, a splitting menu 520, a slider 570, a cancel menu 530, a save menu 540 or the like. However, the matrix size of the grid and the menus are just examples, which may be changed, added or deleted as necessary.

Referring to FIG. 2(a), cells are merged according to an event corresponding to a first input 111 of the user. For example, the first input I11 may be obtained by dragging. When cells are dragged, if a diagonal line is drawn from a first selected cell to a final selected cell, cells in a rectangular area including the diagonal line may be merged. In FIG. 2(a), cells corresponding to the first input I11 are merged to configure an A cell of FIG. 2(b). In addition, in FIG. 2(b), cells corresponding to a second input 112 are merged to configure a B cell of FIG. 2(c).

Finally, in FIG. 2(c), cells corresponding to a third input 113 are merged to configure a C cell of FIG. 2(d). As a result, FIG. 2(d) shows a screen in which a cell merging task is completed, and the grid 550 forms a layout classified into the A cell, the B cell and the C cell, each of which are editable.

Even though cells are merged according to a dragging input of the user in FIG. 2, the input is just an interface for creating an event and may be modified in various ways. As described above, the user may design a layout of the grid in various ways by merging cells through an intuitive manipulation without being limited to a given grid.

Referring to FIG. 3 to explain the cell splitting mode, an editing screen 560 separated into cells is provided on the screen 500 which is provided for editing a layout of the grid. Referring to FIG. 3(a), cells are split according to an event according to a fourth input 121 of the user. For example, the fourth input 121 may be obtained by tapping. If a cell is tapped, the corresponding cell is split into small cells. The split cells are separated into a predetermined grid form or a grid form selected by the user.

According to the second input 121 input to the A cell in FIG. 3(a), the A cell is split into a plurality of cells as show in FIG. 3(b). In addition, according to a fifth input 122 input to the B cell in FIG. 3(b), the B cell is split into a plurality of cells as shown in FIG. 3(c).

Similarly, according to a sixth input 123 input to the C cell in FIG. 3(c), the C cell is split into a plurality of cells as show in FIG. 3(d). As a result, as shown in FIG. 3(d), the A cell, the B cell and the C cell of the editing screen 560 split into a plurality of cells have a layout re-split into a grid 550. Here, each cell of the grid 550 may be edited.

Even though cells are split according to a tapping input of the user in FIG. 3, the input is just an interface for creating an event and may be modified in various ways. As described above, the user may design a layout of the grid in various ways by splitting a grid through an intuitive manipulation without being limited to a given grid.

Referring to FIG. 4 to explain the cell interval adjusting mode, an editing screen 560 separated into cells is provided on the screen 500 for editing a layout of the grid. In addition, a slider 570 for adjusting a cell interval may be provided, and guides 571, 572 for intuitively informing a direction which increases or decreases the cell interval may be provided.

Referring to FIG. 4(a), intervals of cells are adjusted according to an event corresponding to an input 131. For example, the input 131 may be obtained by dragging the slider 570. If the slider 570 is dragged towards a cell interval increase direction (as indicated by guide 572), intervals of the cells increase, but if the slider 570 is dragged towards a cell interval decrease direction (as indicated by guide 571), intervals of the cells decrease. In this way, the cell interval may be controlled according to the degree and direction of dragging.

In FIG. 4(a), for example, intervals of cells increase according to the input 131 obtained by dragging the slider 570 in a first direction, as shown in FIG. 4(b). In addition, if the slider 570 is dragged further in the first direction (an input 132) in FIG. 4(b), intervals of cells increase further as shown in FIG. 4(c). The first direction represents a direction oriented toward the guide 572 in which a wide cell interval is depicted.

In contrast, intervals of cells will decrease to the state shown in FIG. 4(a) according to an input obtained by dragging the slider 570 in a second direction opposite to the first direction. The second direction represents a direction oriented toward the guide 571 in which a narrow cell interval is depicted.

As described above, the user may design a layout of the grid in various ways by adjusting a cell interval through an intuitive manipulation without being limited to a given grid.

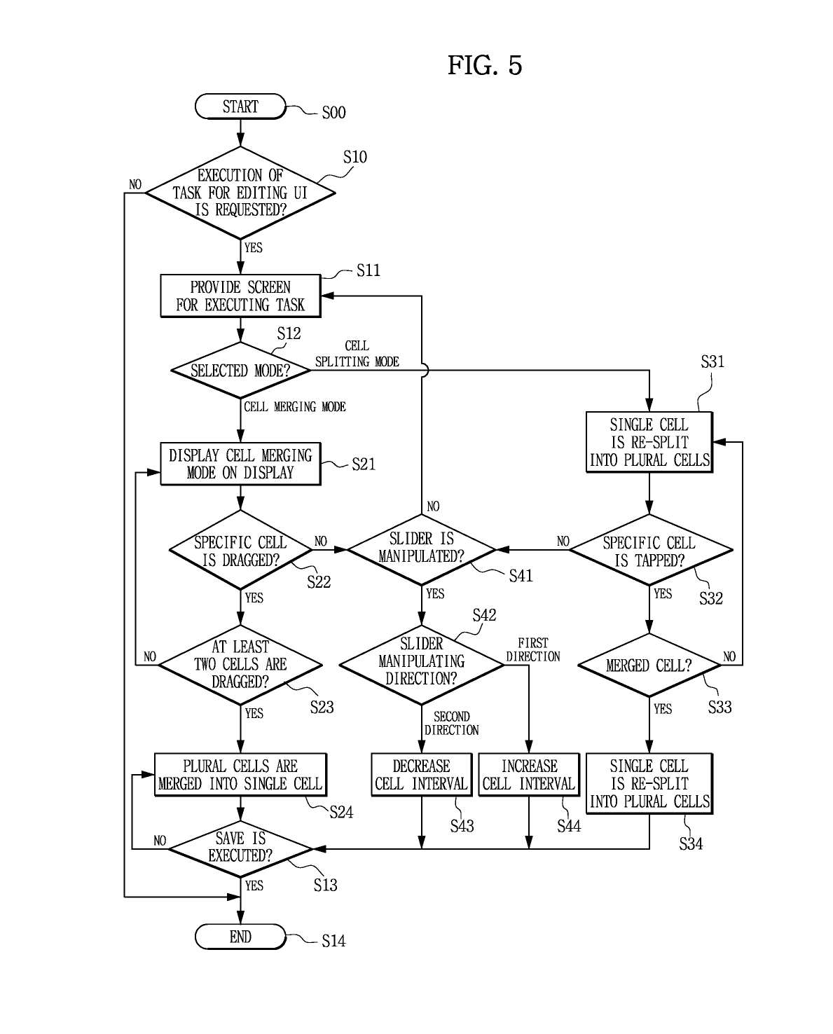

FIG. 5 is a flowchart for illustrating a method for editing a user interface according to an embodiment of the present disclosure.

The method for editing a user interface according to this embodiment may be performed using the substantially same configuration as the terminal of FIG. 1. Therefore, the like elements of terminal 1 of FIG. 1 are designated by the like reference symbols and not described in detail here.

Referring to FIG. 5, a cell merging task, a cell splitting task and a cell interval adjusting task performed by the grid layout processing unit 310 of the terminal 1 will be described. First, when a screen is in a standby state or another program is in operation (Step S00), it is determined whether a task for editing a UI is requested by the user (Step S10). If there is a request for executing a task, the terminal provides a screen for executing the task (Step S11). For example, a cell-based grid for editing may be provided on the screen.

Subsequently, an editing mode selected by the user is determined (Step S12). The editing mode may be selected by the user after a menu is provided, or the editing mode may also be determined according to an event corresponding to an input of the user.

If the cell merging mode is selected, a screen for merging cells is displayed (Step S21). If a specific cell is dragged (Step S22), it is determined whether at least two cells are dragged (Step S23). If at least two cells are dragged, a plurality of cells is merged into a single cell (Step S24). The cell merging mode is depicted in FIG. 2.

If the cell splitting mode is selected, a screen for splitting a cell is displayed (Step S31). If a specific cell is tapped (Step S32), it is determined whether the cell is a merged cell (Step S33). If the cell is a merged cell, the cell is re-split into a plurality of cells (Step S34). The cell splitting mode is depicted in FIG. 3.

In addition, if the user manipulates the slider (Step S41), it is determined that the cell interval adjusting mode is selected. Subsequently, a manipulating direction of the slider is determined (Step S42). If the manipulating direction of the slider is the first direction, a cell interval is increased (Step S44). If the manipulating direction of the slider is the second direction, the cell interval is decreased (Step S43). The cell interval adjusting mode is depicted in FIG. 4.

The cells distinguished in the cell merging mode, the cell splitting mode and the cell interval adjusting mode of the grid and the layout of the grid are saved (Step S13), and then the task is completed (Step S14).

As described above, the user may design a layout of the grid in various ways by merging cells, splitting a cell or adjusting a cell interval through an intuitive manipulation without being limited to a given grid.

If the layout of the grid is completely edited, the user may design the grid by adding a graphical element to each editable cell. The user may edit the grid based on each cell. Hereinafter, an operation for graphically editing a cell will be described.

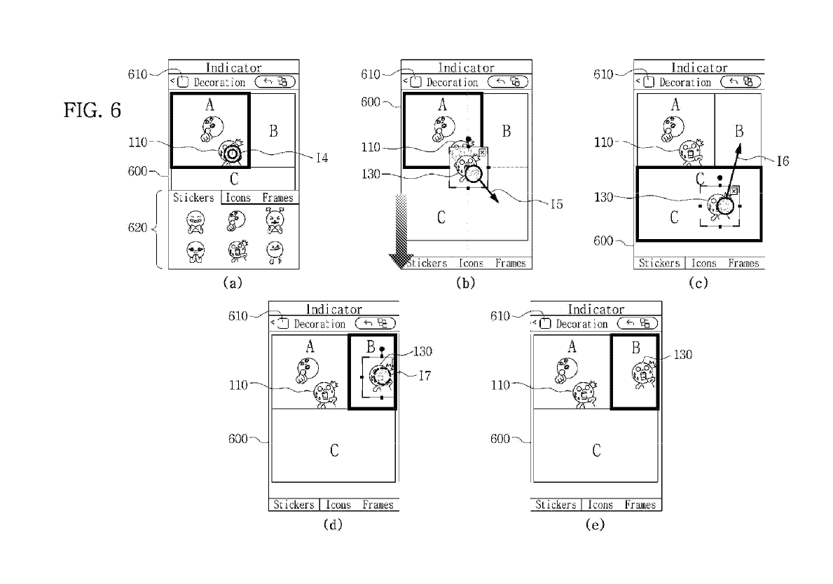

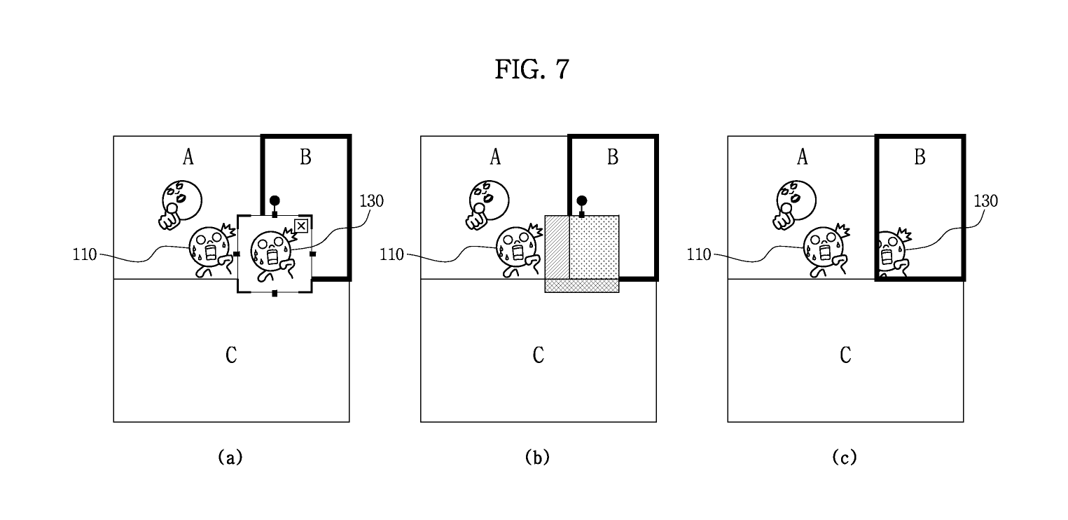

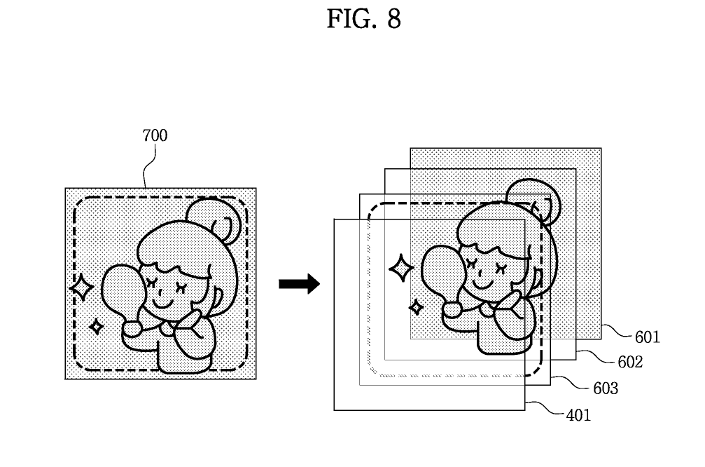

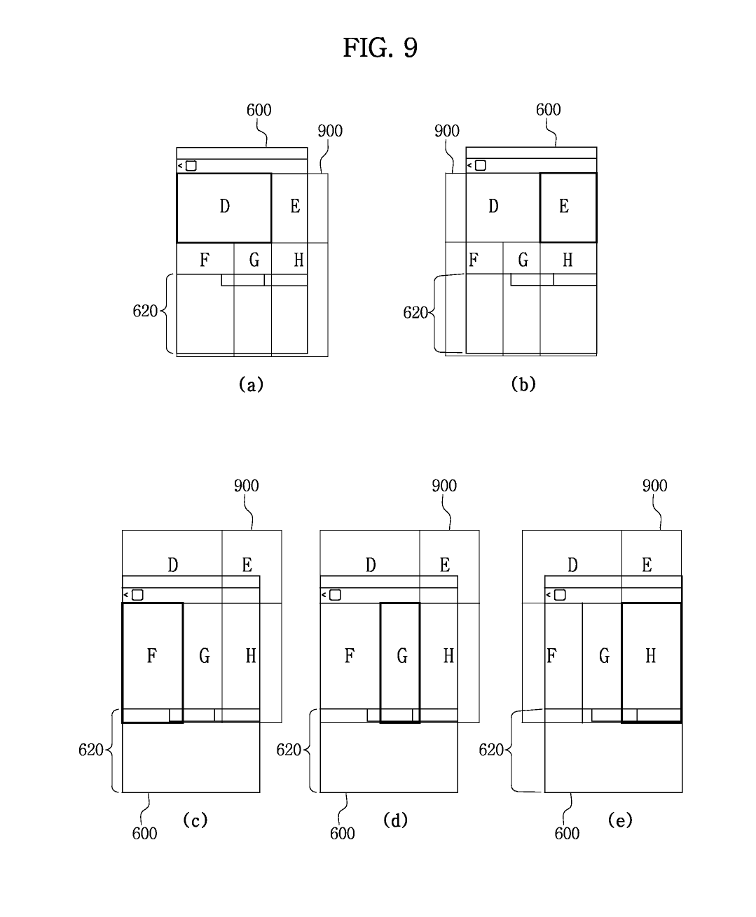

FIGS. 6 and 7 show various screens in which a graphical element of a cell is edited, in the terminal of FIG. 1. FIG. 8 is a diagram showing a layer of a graphical element of a cell. FIG. 9 is a diagram showing an auto scroll of a cell focus.

FIG. 6 depicts a layout and technique for copying or moving an item. Referring to FIG. 6(a), a screen 600 for graphical editing is provided, and the screen 600 is classified into an A cell, a B cell and a C cell which are editable. In addition, a decoration icon 610 and a table 620 for giving items may be provided. If the user inputs an input 14 to an item 110 in the A cell, the A cell is focused and the item 110 is selected. The item 110 may employ any graphical element available in the terminal 1, for example a sticker, an icon, a frame, a picture, an image, a figure, text or the like.

If an input 15 is successively input to the item 110, the item 110 is copied. Together with copying the item 110, the table 620 may be hidden. The input 14 and the input 15 may be a series of successive operations obtained by double tapping or dragging. A cell at which an input of the user is sensed may be focused.

FIG. 6(b) shows a screen in which an item 130 generated when copying the item 110 to the C cell floats. If the copied item 130 is dragged to the C cell, the item 110 is copied to the C cell as shown in FIG. 6(c). In addition, if an input 16 is made for moving the copied item 130 as shown in FIG. 6(c) to the B cell, the item 130 is moved to the B cell as shown in FIG. 6(d). The input 16 may be obtained by dragging the copied item 130 from the C cell to the B cell.

Subsequently, if an input 17 (for example, releasing) is input, the copied item 130 is placed in the B cell as shown in FIG. 6(e). However, the above inputs are just examples and may employ various kinds of inputs using a finger of the user, a touch pen or the like.

FIG. 7 shows an example for illustrating graphical processing when the copied item 130 lies over several cells. Referring to FIG. 7(a), in the screen 600 for graphical editing, the item 130 partially occupies the A cell, the B cell and the C cell. In this case, as shown in FIG. 7(b), a proportion occupied by the item 130 is calculated. In this example, since a proportion in the B cell is highest, the B cell is focused. After that, the item 130 is copied and applied to the B cell as shown in FIG. 7(c).

Referring to FIG. 8, an example of a UI 700 generated after completing editing is depicted. The UI 700 includes at least one graphic layer 601, 602, 603 and a link layer 401 by means of graphical editing. The link layer 401 serves as a layer in which if a specific region is selected by the user, a specific function connected to the corresponding region is executed or an application or program for executing the corresponding function is executed. The link layer 401 is generated by the link executing unit 400 (see FIG. 1) but is depicted together in FIG. 8 for convenience.

The graphic layer may include a background image layer 601 for setting an image or color of a background for a cell, a decoration layer 602 for adding a decoration element such as a sticker, a symbol or a text, and a frame layer 603 for decorating a rim of the cell like a frame. The graphic layers may be added, deleted or changed as necessary, and each layer may also be selected, moved or changed according to the editing mode.

Referring to FIG. 9, in the screen 600 for graphical editing, when a region 900 of a plurality of cells D, E, F, G, H is greater than the screen 600, an auto scroll function is executed so that all cells edited by the user may be viewed.

When a D cell is edited as shown in FIG. 9(a), the region 900 is scrolled to the left while the D cell is focused, so that the entire D cell may be viewed by the user. Similarly, when an E cell is edited as shown in FIG. 9(b), the region 900 is scrolled to the right while the E cell is focused, so that the entire E cell may be viewed by the user.

As shown in FIG. 9(c) to FIG. 9(e), when an F cell, a G cell and an H cell are respectively edited, the corresponding cells are automatically scrolled so that an entire cell edited by the user may be viewed. For example, a focused cell may be viewed using a lower end of a title bar as a start point.

As described above, the user may view a full image of a cell which is being edited even in the limited screen 600, thereby ensuring efficient editing.

If every editable cell is graphically edited, a UI is generated, and the link executing unit 400 links a specific function to each cell. If the cell is selected, a link menu is provided, and if the user selects an item in the menu, the cell is linked to the corresponding item. The link layer 401 (see FIG. 8) may be an invisible or a visible graphic layer.

The link executing unit 400 saves the item mapped with each UI. After that, if the UI is tapped, the link layer 401 is actually tapped and is linked to an item which executes a specific function. For example, if a camera function is linked to a generated UI, when the UI is selected, the camera function is executed. In addition, if a web browser is linked to a generated UI, when the UI is selected, the web browser is executed.

Accordingly, the user may creatively design a UI for executing a specific application, a specific function or a specific task, and may also intuitively use the terminal by means of the UI.

According to the present disclosure, a UI may be edited in various ways, and a home screen may be designed in various ways beyond the limit of an OS of the terminal. In addition, beyond an existing limited design where a photograph is inserted into a template prepared in advance and text is input to a specific region, it is possible to creatively design a mobile card, a wedding invitation, an invitation card or the like, and in this case, a URL link may be provided thereto so that a web page may be linked thereto.

In addition, even in existing album production which just allows photographs to be inserted into a grid prepared in advance, it is possible for the user to directly decorate an album and design various layouts in the terminal. Further, in a mobile web page, portfolios and personal web sites may be designed in various ways according to a demand or taste of the user.

As described above, if the terminal and method for editing a user interface according to the present disclosure is used, since a layout and graphic editing function and a link function are provided, the user may efficiently configure a UI, and a unique result may be obtained by means of an intuitive input.

While the exemplary embodiments have been shown and described, it will be understood by those skilled in the art that various changes in form and details may be made thereto without departing from the spirit and scope of the present disclosure as defined by the appended claims.

What is claimed is:

1. A mobile terminal with a configurable user interface comprising:
a display for displaying a user interface;
an input device for receiving user input; and
a user interface editor for configuring the user interface including a grid manager, the grid manager including a grid layout processor for forming a grid in the display and separating the grid into editable cells, the grid manager further including a graphic processor that adds one or more graphical elements to one or more of the editable cells of the grid to create the user interface.

2. A mobile terminal with a configurable user interface according to claim 1 wherein the input device is selected from one or more of a touchscreen interface, a touchpad interface, or a keypad interface.

3. A mobile terminal with a configurable user interface according to claim 1 wherein the grid manager includes a menu for editing.

4. A mobile terminal with a configurable user interface according to claim 3 wherein the menu for editing includes one or more application icons, widgets, thumbnails, home screens, frames, pictures, images, figures, text, or stickers.

5. A mobile terminal with a configurable user interface according to claim 1 wherein the display is selected from liquid crystal displays, plasma displays, OLED displays, electronic paper, or electroluminescent displays.

6. A mobile terminal with a configurable user interface according to claim 1 wherein the grid layout processor further comprises a cell merger, a cell splitter, and a cell interval adjuster configured to control aspects of the grid layout.

7. A mobile terminal with a configurable user interface according to claim 1 further comprising a link executer for saving the one or more graphical elements mapped to one or more of the editable cells of the grid and linking a corresponding function associated with the one or more graphical elements to the cell in which it has been mapped.

8. A mobile terminal with a configurable user interface according to claim 7 further comprising an invisible or visible graphic link layer cooperating with the link executer to execute the corresponding function of the one or more graphical elements mapped to the cell.

9. A method for configuring a user interface in a mobile terminal comprising:
opening a screen for executing a user interface editing function;
selecting an editing mode from one or more of a cell merging mode, a cell splitting mode, or a cell interval adjusting mode and editing a cell configuration to form a designated cell configuration; and
adding one or more graphical elements to one or more cells in the designated cell configuration to form the user interface.

10. A method for configuring a user interface in a mobile terminal according to claim 9 wherein the screen is a cell-based grid.

11. A method for configuring a user interface in a mobile terminal according to claim 9 wherein the cell merging mode merges two or more cells together to form a larger cell.

12. A method for configuring a user interface in a mobile terminal according to claim 9 wherein the cell splitting mode splits a single cell into two or more smaller cells.

13. A method for configuring a user interface in a mobile terminal according to claim 9 wherein the cell interval adjusting mode widens or narrows a border region between cells.

14. A method for configuring a user interface in a mobile terminal according to claim 9 wherein the adding one or more graphical elements to one or more cells in the designated cell configuration comprises selecting the graphical element from a table.

15. A method for configuring a user interface in a mobile terminal according to claim 9 wherein the one or more graphical elements are selected from an application icon, a frame, a picture, an image, a figure, text, a sticker, a widget, a thumbnail, or a home screen.

16. A method for configuring a user interface in a mobile terminal according to claim 9 wherein, when a selected graphical element overlaps plural cells, the editing mode determines the cell with the largest overlap and places the graphical element in that cell.

17. A method for configuring a user interface in a mobile terminal according to claim 9 wherein when a region of plural cells is greater than a region of the screen, an auto scroll function is executed by the editing mode so that all of the plural cells are viewable.

18. A mobile terminal for editing a user interface comprising:
an input portion for receiving an input of a user;
a user interface editor for providing a grid which is editable according to the input of the user, the user interface editor configured to map a graphical item and a specific function to be connected to the grid according to selections by the user; and
a display for displaying a user interface configured by the user interface editor.

19. A mobile terminal for editing a user interface according to claim 18 wherein the user interface editor further comprises a grid layout processor and a graphic processor.

20. A mobile terminal for editing a user interface according to claim 19 wherein the grid layout processor further comprises a cell merger, a cell splitter, and a cell interleaving adjuster.
